(19) United States
(12) Patent Application Publication
(10) Pub. No.: US 2014/0299096 A1
(43) Pub. Date: Oct. 9, 2014

(54) DEVICE FOR CONTROLLING AN INTERNAL COMBUSTION ENGINE

(71) Applicant: Andreas Rupp, Marbach (DE)

(72) Inventor: Andreas Rupp, Marbach (DE)

(21) Appl. No.: 14/114,951

(22) PCT Filed: Mar. 19, 2012
(86) PCT No.: PCT/EP2012/054773

§ 371 Date: Feb. 4, 2014

(30) Foreign Application Priority Data
May 3, 2011 (DE) 10 2011 075 151.3

(51) Int. Cl. F02D 41/30

(52) U.S. Cl. CPC F02D 41/30
USPC 123/344

(57) ABSTRACT

A device for controlling an internal combustion engine in a motor vehicle having an uneven running ascertaining unit and an injection quantity correction unit, in which one group of cylinders being associated with a lambda sensor, in which the uneven running ascertaining unit determines the uneven running of a cylinder and compares it with a predefinable threshold value. If the ascertained uneven running exceeds the predefinable threshold value, the injection quantity correction unit adjusts the injection quantity of the cylinder in the rich direction and adjusts the injection quantities of the other cylinders of the group, so that on the whole a predefinable lambda value of the group, which may be a lambda value of 1, is achieved, and a lambda deviation is determinable for each individual cylinder in an adaption unit.

### FIELD OF THE INVENTION

The present invention relates to a device for controlling an internal combustion engine.

### BACKGROUND INFORMATION

A device for coordinating the torque contributions for individual cylinders in a multicylinder internal combustion engine is discussed in DE 198 28 279 A1, for example. Using this device, a cylinder coordination is carried out on the basis of the total torque. Setpoint values are determined from individual uneven running values for the individual cylinders. The coordination takes place only during lean operation. The object of the device known from that patent is primarily to optimize uneven running.

The air-fuel ratio during homogeneous operation of a gasoline engine is controlled by lambda regulation in such a way that the average of all cylinders is lambda=1.0, thus permitting low-emission operation using three-way catalytic converters. Metering tolerances of the fuel injectors and air/filling differences in individual cylinders due to system tolerances, for example, may then result in different lambda values in the individual cylinders, although the global total lambda assumes a value of 1.0 over all cylinders. Thus, in a four-cylinder engine, for example, the lambda of the first cylinder may be λ_{cyl1}=1.1, the lambda value of the second cylinder may be λ_{cyl2}=0.9, the lambda value of the third cylinder may be λ_{cyl3}=1.2 and the lambda value of the fourth cylinder may be λ_{cyl4}=0.8. This results in a total lambda of 1.0. The so-called “trimming” of the lambda value for each individual cylinder results directly in an increase in fuel consumption. If this trimming exceeds a certain threshold value, the emission also changes to the negative, i.e., the emission values become worse. However, such emissions deterioration must be detected and/or eliminated through suitable control strategies because of statutory requirements in the United States in particular.

Such a control strategy is discussed in DE 10 2006 026 390 A1 which relates to an electronic control unit for controlling an internal combustion engine in a motor vehicle using an uneven running ascertaining unit and an injection quantity correction unit, where a defined group of cylinders is assigned to one lambda sensor. Using this control device, the injection quantity of a cylinder to be tested in the defined group is adjusted in the lean direction by a differential adjustment value assigned to an uneven running differential value, and the injection quantity of at least one of the other cylinders assigned to the same lambda sensor is adjusted in the rich direction accordingly, so that a predefined lambda value of at least almost 1 is achieved on the whole in this group. This ensures a homogeneous operation. The differential adjustment values may relate to the injection quantity itself, the injector stroke or the injection time, for example.

Using this control device, a differential adjustment value for each individual cylinder of the defined group is set in the same way. Correction values are subsequently determined for each individual cylinder by defining a ratio of the differential adjustment values for the individual cylinders in relation to one another. Using this adjustment in the lean direction for error detection and for ascertaining a correction value should not depart from a homogenous engine operation and a controlled catalytic converter concept for “lambda 1” in particular. The emission limits described previously should be reliably maintained. The predefined uneven running differential values for achieving a defined target lambda value are ascertained empirically and saved under error-free conditions; they may be predefinable variably as a function of the operating point.

A cylinder in which a misfire has been detected is artificially enriched using this control device, so that the detection method, the so-called ramp to lean, for this cylinder is subsequently restarted.

This control method and the control device have an unsatisfactory detection quality in the case of lean errors. The cause is the declining curvature of the characteristic line η(λ) with an increase in lambda. FIG. 1 shows efficiency η schematically as a function of air ratio λ of a cylinder. In the emphasized range 10, which is between λ=0.7 and λ=1.2, the emission limit is still not exceeded. FIG. 2 shows leaning demand Δλ as a function of λ, which is necessary to achieve an uneven running difference of 12%. Starting from its individual air ratio λ, a cylinder must be leaned by Δλ to achieve an uneven running difference of 12%. In the emphasized range, labeled with reference numeral 20 here, the required leaning Δλ differs only slightly from initial air ratio λ. The curve is very flat in this range, so that required leaning Δλ may be difficult to determine. This inaccuracy increases with an increase in air ratio λ.

The control method now determines leaning demand Δλ of a cylinder, which is necessary to achieve a predefined uneven running difference. The method then assigns an absolute starting lambda value to this leaning demand. In the case of a characteristic line η(λ) having only a slight curvature (see FIG. 1), almost the same leaning demand is necessary for two different starting lambda values to achieve the previously defined uneven running difference. However, since only one lambda value is assigned to the measured leaning demand, the method is inaccurate under these given conditions. If the characteristic line η(λ) does not have a curvature, then the starting lambda value cannot be inferred from the measured leaning demand.

### SUMMARY OF THE INVENTION

The present invention is based on the object of improving upon a device for controlling an internal combustion engine in such a way that any deterioration of exhaust emissions, in particular lean errors, are reliably detected and eliminated, so that the exhaust emissions do not change in an adverse manner.

This object may be achieved by a device for controlling an internal combustion engine having the features described herein.

One aspect of the device according to the present invention for controlling an internal combustion engine is not to carry out an artificial enrichment, a so-called preliminary enrichment of a cylinder, only when there has been one or multiple misfire(s) but instead already when it is suspected that the cylinder currently in question is too lean. It is decided according to the present invention when this suspicion occurs by comparing the uneven running of a cylinder with a predefinable threshold value. In the control device according to the present invention, this value of air ratio X is shifted into the rich range to a certain extent due to the artificial enrichment, i.e., it is shifted to the left in the curves in FIG. 1 and FIG. 2 to thereby permit better and more accurate determination of leaning demand Δλ.

There is suspicion that a cylinder is too lean when at least one of the following situations is applicable:
there is a great uneven running difference with even a minor leaning;
the required leaning to achieve a predefined uneven running difference is too low; in this case the final leaning value is evaluated;
long ramps to lean have become necessary when the number of cylinders corresponds to more than half the cylinder number or
after each ramp an average is calculated for the leaning to be expected of the following cylinders. This value exceeds an applicable threshold.

It is believed that an advantage of the device according to the present invention is also that a preliminary enrichment takes place already before any misfires occur.

The further descriptions herein relate to advantageous embodiments and refinements of the device defined herein. Thus, the estimate of the average of the leaning to be expected of the other cylinders is advantageously determined with the aid of this equation after evaluating one cylinder:

$$Δ \hat{λ} = \frac{1}{{z}_{cyl} - {i}_{act}} ( {z}_{cyl} \cdot Δ {λ}_{theor} - {\sum }_{i = 1}^{i = {i}_{act}} Δ {λ}_{Ai} )$$

in which Δ\hat{λ} denotes the estimated leaning demand for the following cylinders, where it is assumed that the following cylinders on the average require the same leaning demand Δ\hat{λ};

Δλₜₕₑₒᵣ denotes a leaning which is necessary, starting from λ=1 to achieve a predefined and applicable uneven running difference; Δλ_{Ai} denotes the required leaning for cylinder i, where it holds that 1≦i_{act}≦z_{cyl}−1, where z_{cyl}=number of cylinders; the subscript “act” stands for the current cylinder.

Exemplary embodiments of the present invention are depicted in the drawings and explained in greater detail in the following description.

### BRIEF DESCRIPTION OF THE DRAWINGS

FIG. 1 schematically shows the efficiency known from the related art as a function of air ratio λ of a cylinder of an internal combustion engine.

FIG. 2 schematically shows the required leaning of a cylinder as a function of air ratio λ to achieve an uneven running difference of 12%.

FIG. 3 schematically shows the uneven running as a function of the lambda value to explain the control device according to the present invention.

FIG. 4 schematically shows a block diagram of the control device according to the present invention.

### DETAILED DESCRIPTION

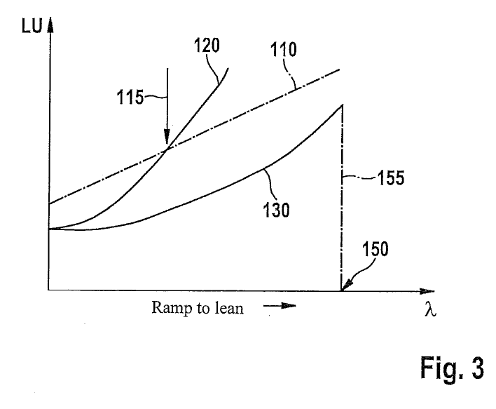

FIG. 3 schematically shows uneven running LU as a function of air ratio λ to illustrate the control device according to the present invention. In the control method according to the present invention, an artificial enrichment, a so-called preliminary enrichment of a cylinder, is carried out not only after one or multiple misfires but instead already when there is a suspicion that the cylinder currently being considered is too lean.

The suspicion that a cylinder is lean occurs when at least one of the following situations is applicable:
1. there is a great uneven running difference already with a minor leaning;
2. the required leaning to achieve the predefined applicable uneven running difference is too small—hence the final leaning value is evaluated here;
3. long ramps to lean have already become necessary at a number of cylinders corresponding to more than half the cylinder number or
4. after each ramp, an average is calculated for the leaning to be expected of the following cylinders. If this value exceeds a predefinable applicable threshold, it is assumed that a cylinder is lean.

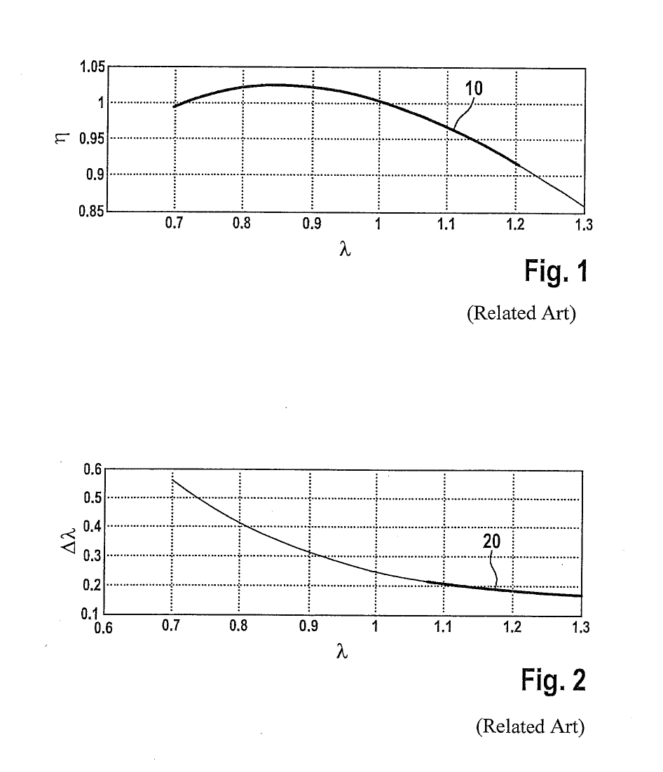

This permits faster detection of a lean error. The preliminary enrichment takes place here when there is a great uneven running difference already with a minor leaning. A threshold 110 for the uneven running difference is therefore calculated as a function of a prevailing ramp value, which takes into account the uneven running increase to be expected in the normal case as the result of a leaning. Therefore, the uneven running difference occurring with a leaning from the state λ=1 to the lambda value at which a device known from the related art for controlling the internal combustion engine is still accurate enough and there still should not be any preliminary enrichment. If the measured uneven running difference exceeds this threshold 110, which is the case at a point 115 in the figure, then a preliminary enrichment takes place. However, if the measured large difference does not exceed this applicable threshold 110, shown on the basis of the curve 130 in FIG. 1, then it is assumed that there is no leaning of the cylinder. The ramp to lean ends at a predefinable lambda value 150, this end being depicted schematically by a line 155 in FIG. 3.

After each ramp, an average value is calculated for the leaning to be expected of the following cylinders, where a leaning of Δλₜₕₑₒᵣ is necessary, starting from λ=1, to achieve the applied uneven running difference. Depending on the evaluated cylinder, 1≦i_{act}≦z_{cyl}−1, the average of the other cylinders may be estimated according to the following equation (the total number of cylinders is z_{cyl}):

$$Δ \hat{λ} = \frac{1}{{z}_{cyl} - {i}_{act}} ( {z}_{cyl} \cdot Δ {λ}_{theor} - {\sum }_{i = 1}^{i = {i}_{act}} Δ {λ}_{Ai} ) .$$

where Δ80 _{Ai} denotes the required leaning for cylinder i. Thus, if a shift in the rich direction is expected for the remaining cylinders i+1 . . . z_{cyl}, then the enrichment is omitted. If a shift in the lean direction is expected, then an enrichment may take place. A shift in the lean direction is expected when Δ\hat{λ}<Δλₜₕₑₒᵣ. Conversely, a shift in the rich direction is expected when Δ\hat{λ}>Δλₜₕₑₒᵣ. This equation calculates the average leaning Δ\hat{λ} to be expected for the following cylinders, starting from leaning Δλₜₕₑₒᵣ required in the ideal case and taking into account leaning Δλ_{Ai} already implemented.

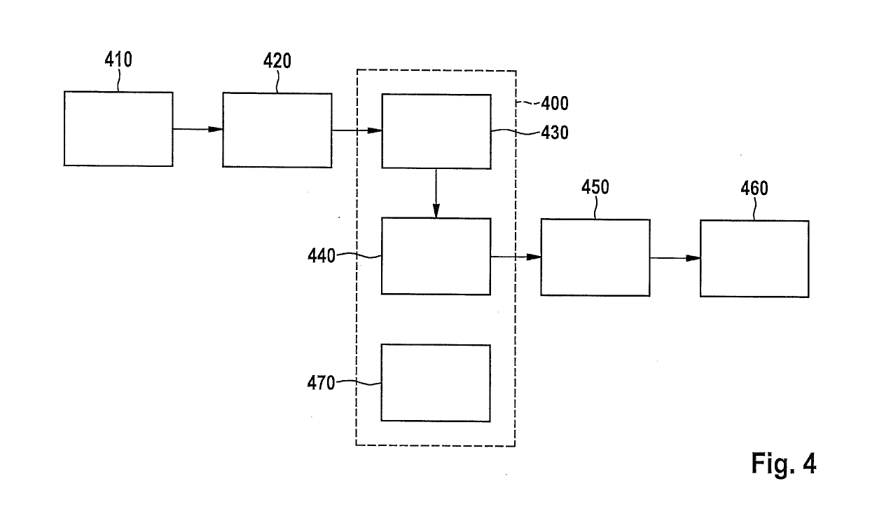

FIG. 4 schematically shows a block diagram of a control device according to the present invention.

Uneven running is determined with the aid of an uneven running ascertaining unit 420. This may be done, for example, by selecting from an engine characteristics map a predefined uneven running difference value at a certain point in time as a setpoint value at a current operating point of the internal combustion engine as a function of the engine rotational speed, which is detected with the aid of a rotational speed detection unit 410 and the load. The output signal of uneven running ascertaining unit 420 is sent to a unit for ascertaining the suspicion of a lean cylinder 430, which is part of the control device according to the present invention. The criteria cited above are used to determine whether there is a so-called lean cylinder. The lambda values for the individual cylinders are ascertained in an adaptation unit 440 for determining lambda values for individual cylinders, and then starting from these lambda values, a correction of the injection quantity is determined in an injection quantity correction unit 450 and is made available to fuel injection 460. Circuit block 470 is a sequence controller for the unit for ascertaining the suspicion of a lean cylinder 430 and the unit for detecting lambda values 440 for individual cylinders. These circuit units are part of a circuit 400.

The cylinders are adjusted in the lean direction in accordance with their firing sequence until reaching the predefined uneven running differential value. The adjustment may take place suddenly and/or in the form of a ramp. The two variants may also be combined purely in principle, i.e., for example, initially a sudden adjustment and only then a ramp adjustment. The injection quantity of a first cylinder to be tested is initially adjusted by a differential adjustment value in the lean direction to achieve the predefined uneven running differential value. The injection quantities of the other cylinders may be adjusted in the rich direction in approximately equal amounts accordingly, so that on the whole a lambda value of at least approximately 1 is achieved. Differential adjustment values for each individual cylinder are determined and adjusted one after the other in this way. The average of all differential adjustment values is subsequently formed. The differences between this average and the individual differential adjustment values are each stored as cylinder-individual correction values and are then made available for correction of the injection quantities accordingly. According to the present invention, this control process already takes place when the uneven running difference exceeds predefined threshold value 110. There is thus an artificial enrichment of a cylinder not just after one or multiple misfire(s) but instead already when there is a suspicion that the cylinder currently in question is too lean.

1-2. (canceled)

3. A device for controlling an internal combustion engine in a motor vehicle, comprising:
an uneven running ascertaining unit; and
an injection quantity correction unit, wherein a group of cylinders is assigned to a lambda sensor;
wherein the uneven running ascertaining unit is configured to determine the uneven running of a cylinder and compare it with a predefinable threshold value, and when the ascertained uneven running exceeds a predefinable threshold value, the injection quantity correction unit adjusts the injection quantity of the cylinder in the rich direction, and the injection quantities of the other cylinders of the group are adjusted so that a predefinable lambda value of the group is achieved on the whole, and a lambda value deviation for each individual cylinder is determinable in an adaptation unit.

4. The device of claim 3, wherein an enrichment of a cylinder i_{act}+1 takes place when the following equation holds:
$$Δ \hat{λ} = \frac{1}{{z}_{cyl} - {i}_{act}} ( {z}_{cyl} \cdot Δ {λ}_{theor} - {\sum }_{i = 1}^{i = {i}_{act}} Δ {λ}_{Ai} ) < Δ {λ}_{theor}$$
where Δλₜₕₑₒᵣ is a leaning, which is necessary starting from λ=1 to achieve a predefined and applicable uneven running difference, Δλ_{Ai} is the required leaning for the cylinder, where 1<i_{act}≦z_{cyl}−1 is applicable, where z_{cyl}=number of cylinders and Δ\hat{λ} denotes the estimated leaning demand for the cylinders to follow.

5. The device of claim 4, wherein the lambda value is 1.

6. The device of claim 3, wherein the lambda value is 1.
